(19) United States
(12) Patent Application Publication
(10) Pub. No.: US 2009/0010642 A1
(43) Pub. Date: Jan. 8, 2009

(54) METHOD FOR MEASURING FIBER LENGTH, OPTICAL LINE TERMINAL AND OPTICAL NETWORK SYSTEM

(76) Inventors: Meng Sui, Shenzhen (CN); Sulin Yang, Shenzhen (CN); Hai Gao, Shenzhen (CN); Feng Wang, Shenzhen (CN)

Correspondence Address: BRINKS HOFER GILSON & LIONE, P.O. BOX 10395, CHICAGO, IL, 60610, US

(21) Appl. No.: 12/234,308

(22) Filed: Sep. 19, 2008

Related U.S. Application Data
(63) Continuation of application No. PCT/CN2008/070758, filed on Apr. 20, 2007.

(30) Foreign Application Priority Data
Apr. 20, 2007 (CN) 200710098197.7

(51) Int. Cl. H04B 10/08

(52) U.S. Cl. 398/9

(57) ABSTRACT

A method for measuring fiber length, an optical line terminal and an optical network system. The method for measuring fiber length according to the embodiment of the present invention includes the following steps: Sending the first message to an optical network device at the subscriber side; —Receiving the second message, which is a response returned by the optical network device at the subscriber side to the first message; —Determining the duration between sending the first message and receiving the second message; Calculating the length of the fiber to the optical network device at the subscriber side according to the above-mentioned duration and the information related to the processing delay of the optical network device at the subscriber side, wherein the information related to the processing delay of the optical network device at the subscriber side includes the actual response time of the optical network device at the subscriber side.

### CROSS-REFERENCE TO RELATED APPLICATIONS

This application is a continuation of International Application No. PCT/CN2008/070758, filed Apr. 21, 2008, which claims the priority of CN application No. 200710098197.7 filed Apr. 20, 2007, titled “method for measuring fiber length, optical line terminal and optical network system”, the entire contents of all of which are incorporated herein by reference.

### FIELD

The present embodiments relate to optical network technologies, in particular, to measuring fiber length.

### BACKGROUND

Optical access technologies are rising along with the booming development of the Digital Subscriber Line (DSL) technology in the Access Network (AN) field. Passive Optical Network (PON) technology, as a point-to-multipoint optical access technology, is also being used. A PON includes Optical Line Terminals (OLTs), Optical Network Units (ONUs) or Optical Network Terminals (ONTs), and an Optical Distribution Network (ODN). The ODN provides an optical splitting function and includes passive devices, such as optical splitters. An OLT is located in a Central Office (CO). An ONU/ONT is located at the subscriber side and placed in a dwelling unit, or an enterprise unit, or a Multi-Dwelling Unit (MDU), or a Multi-Tenant Unit (MTU). The difference between an ONU and an ONT is that an ONT is located at the subscriber side but there are other networks such as an Ethernet between an ONU and subscribers.

Typical PONs include Gigabit Passive Optical Networks (GPONs) and Ethernet Passive Optical Networks (EPONs).

FIG. 1 shows a PON system. As shown in FIG. 1, the PON system employs a tree topology structure. The PON is connected via a fiber with the central office and may be connected via dozens of or even more optical fibers with subscribers. As compared with point-to-point connections, the PON involves a low network construction cost.

In the PON system, an OLT needs to acquire the length of the fibers between OLT and ONUs/ONTs, so as to exercise effective operation and maintenance of the PON system.

FIG. 2 shows a technical solution that may be adopted to measure the length of the fiber between an OLT and an ONU/ONT.

FIG. 2 shows the flow chart of a method given for measuring the length of the fiber between an OLT and an ONU/ONT. The method consists of the following acts.

In act 201, an OLT20 sends a ranging request message to an ONU/ONT21 and starts counting.

In act 202, upon receipt of the ranging request message, the ONU/ONT21 waits for a time that is the total processing delay of the ONU/ONT21, such as the sum of the Response Time, Pre-equalization delay, and start time defined in ITU-T G.984.

In act 203, when the total processing delay ends, the ONU/ONT21 returns a ranging response message to the OLT20. Upon receipt of the ranging response message, the OLT20 stops counting.

As shown in FIG. 2, the counting duration, which is the duration obtained by time counting, is the sum of the total processing delay of the ONU/ONT21 and the round-trip time of a message transmitted between the OLT20 and the ONU/ONT21. The OLT20 may deduct the total processing delay of the ONU/ONT21 from the counting duration to obtain the round-trip time of a message transmitted between the OLT20 and the ONU/ONT21, divide the round-trip time by 2, and then multiple the results by the transmission speed of light in a fiber to acquire the length of the fiber between the OLT20 and the ONU/ONT21.

The total processing delay of the ONU/ONT21 is the sum of the waiting time assigned to the ONU/ONT21 and the response time of the ONU/ONT21. The waiting time assigned to the ONU/ONT21 refers to the delay assigned by the OLT20 to the ONU/ONT21, so that the uplink signal of the ONU/ONT21 arrives at the OLT20 with the correct phase to avoid communication conflicts. The OLT20 assigns a waiting time, such as the pre-equalization delay 2021 and the sending start time 2022, shown in FIG. 2, to the ONU/ONT21. The response time of the ONU/ONT21 is the response time 2023, which is shown in FIG. 2. The pre-equalization delay 2021 of the ONU/ONT21 may correspond to the Pre-equalization defined in ITU-T G.984.3, whereas the sending start time 2022 of the ONU/ONT21 may correspond to the SStart defined in ITU-T G.984.3. The two values are assigned by the OLT20. The response time 2023 of the ONU/ONT21 may be any value within the reference value range defined in the PON protocol. The reference value range is 35±1 μs. Accordingly, the OLT20 may use any value within the reference value range as the approximate response time of the ONU/ONT21 to calculate the fiber length.

The length of the fiber between the OLT20 and the ONU/ONT21 calculated according to the reference value range of the response time of the ONU/ONT21 defined in the PON protocol is not conducive to further operation and maintenance of the PON system.

### SUMMARY

The present embodiments relate to a method for measuring fiber length, an optical line terminal, an optical network device, and an optical network system, so as to exactly measure the length of the fiber between an OLT and an ONU/ONT.

In one embodiment, a method for measuring fiber length is provided. The method includes sending the first message to an optical network device at the subscriber side; receiving the second message, which is a response returned by the optical network device at the subscriber side to the first message; determining the duration between sending the first message and receiving the second message; calculating the length of the fiber to the optical network device at the subscriber side according to the above-mentioned duration and the information related to the processing delay of the optical network device at the subscriber side, wherein the information related to the processing delay of the optical network device at the subscriber side includes the actual response time of the optical network device at the subscriber side.

In one embodiment, an Optical Line Terminal (OLT) is provided. The OLT includes a sending unit, a receiving unit, a time couting unit, and a computation unit. The sending unit is operable to send messages, such as a first message to an optical network device at the subscriber side. The receiving unit receives messages, such as a second message which is a response to the first message from the optical network device at the subscriber side. The time counting unit is connected to both the sending unit and the receiving unit to count the time of the first message sent by the sending unit and the time of the second message received by the receiving unit so as to obtain the duration between sending the first message and receiving the second message. The computation unit is connected to the time counting unit to calculate the length of the fiber to the optical network device at the subscriber side according to the duration obtained by the time counting unit and the information related to the processing delay of the optical network device at the subscriber side. The information related to the processing delay of the optical network device at the subscriber side includes the actual response time of the optical network device at the subscriber side.

An optical network device may include a receiving unit, a response time storage unit, and a sending unit. The receiving unit receives messages including the first message from an Optical Line Terminal (OLT). The response time storage unit stores the actual response time of the optical network device. The sending unit sends messages including the second message which is a response to the first message and the information related to the processing delay of the optical network device to the OLT. The information related to the processing delay of the optical network device includes the actual response time of the optical network device.

The optical network system includes an Optical Line Terminal (OLT), which is connected to an optical network device at the subscriber side. The optical network system sends the first message to the optical network device at the subscriber side, receives the second message that is a response to the first message from the optical network device at the subscriber side, determines the time duration between sending the first message and receiving the second message, calculates the length of the fiber to the optical network device at the subscriber side according to the above-mentioned duration and the information related to the processing delay of the optical network device at the subscriber side, wherein the information related to the processing delay of the optical network device at the subscriber side includes the actual response time of the optical network device at the subscriber side.

In one embodiment, an OLT calculates the length of the fiber between itself and an ONU/ONT according to the actual response time of the ONU/ONT. The fiber length obtained through the calculation is precise. Therefore, the precision of the length of the fiber between an OLT and an ONU/ONT obtained through measurement according to the embodiments of the present invention is much higher than that according to the prior art.

### BRIEF DESCRIPTION OF THE DRAWINGS

The following drawings are merely intended to further demonstrate and illustrate the present embodiments, but not to limit the scope of the present embodiments.

FIG. 1 is a schematic diagram illustrating the structure of a PON system according to the prior art;

FIG. 2 is a schematic diagram illustrating the ranging process according to the prior art;

FIG. 3 is a schematic flowchart illustrating a method for measuring fiber length according to Embodiment 3;

FIG. 4 is a schematic flowchart illustrating a method for measuring fiber length according to Embodiment 4;

FIG. 5 is a schematic flowchart illustrating a method for measuring fiber length according to Embodiment 5;

FIG. 6 is a schematic diagram illustrating the structure of an ONU/ONT according to Embodiment 6 of the present invention;

FIG. 7 is a schematic diagram illustrating the structure of another ONU/ONT according to Embodiment 6;

FIG. 8 is a schematic diagram illustrating the structure of an ONU/ONT according to Embodiment 7;

FIG. 9 is a schematic diagram illustrating the structure of an OLT according to Embodiment 8;

FIG. 10 is a schematic diagram illustrating the structure of an OLT according to Embodiment 9;

FIG. 11 is a schematic diagram illustrating the structure of an OLT according to Embodiment 10;

FIG. 12 is a schematic diagram illustrating the structure of a communication system comprising an OLT provided according to Embodiment 11;

FIG. 13 is a schematic diagram illustrating the structure of a communication system provided according to Embodiment 11; and

FIG. 14 is a schematic diagram illustrating the structure of a communication system provided according to Embodiment 11.

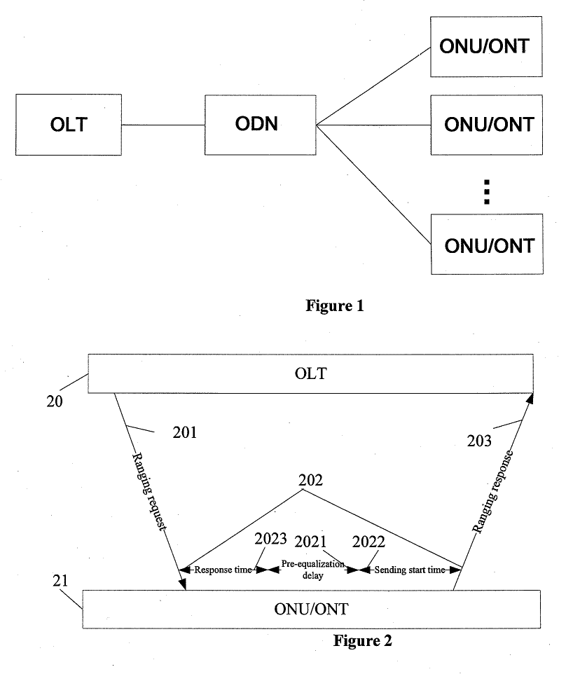

### DETAILED DESCRIPTION

The following drawings and embodiments are merely intended to further demonstrate and illustrate the present embodiments, but not to limit the scope of the claimed subject matter.

Embodiments 1 through 5 relate to methods for measuring fiber length.

### Embodiment 1

In Embodiment 1, the actual response time of an ONU/ONT connected to an OLT may be manually recorded in advance on the OLT after the system installation is complete. Specifically, the information recorded in advance on the OLT may be a mapping between the identifiers of the ONUs/ONTs and the actual response time of these ONUs/ONTs, so that the OLT may query the local records when necessary to obtain the actual response time of an ONU/ONT according to the identifier of the ONU/ONT.

After the above presetting, a measurement method may be utilized to measure the duration that starts when the OLT sends a ranging request message and ends when the OLT receives a ranging response message from the ONU/ONT. Before calculating the length of the fiber between the OLT itself and the ONU/ONT, the OLT queries the local records to obtain the actual response time of the ONU/ONT. Then the OLT calculates the length of the fiber between itself and the ONU/ONT according to the actual response time of the ONU/ONT.

In Embodiment 1, the actual response time of each ONU/ONT connected to an OLT can be manually recorded in advance on the OLT, so that the OLT can query the local records to obtain the actual response time of each ONU/ONT. The OLT may calculate the length of the fiber between itself and the ONU/ONT according to the actual response time of the ONU/ONT. The obtained fiber length is precise. Compared with the method for measuring fiber length, which takes any response time value of the ONU/ONT within the error range defined by the protocol as the actual response time, Embodiment 1 improves the precision of the measured fiber length.

### Embodiment 2

ONUs/ONTs with same brand and model have the same actual response time. In Embodiment 2, the actual response time of the ONUs/ONTs with various brands and models can be manually recorded in advance on the OLT after the system installation is complete. The information manually recorded on the OLT may be a mapping between the identifiers of various brands and models of the ONUs/ONTs and the actual response time of these ONUs/ONTs, so that the OLT can query the local records to obtain the actual response time of the ONUs/ONTs according to the identifiers after the ONUs/ONTs are registered.

The method according to Embodiment 2 includes: measuring the duration between the time when the OLT sends a ranging request message and the time when the OLT receives a ranging response message from the ONU/ONT; the OLT queries the local records to obtain the corresponding actual response time of the ONU/ONT; the OLT calculates the length of the fiber between the OLT and the ONU/ONT according to the actual response time of the ONU/ONT.

As mentioned previously, in Embodiment 2, the actual response times of ONUs/ONTs of various brands and models are recorded in advance on the OLT, such as a mapping between the identifiers of ONUs/ONTs of various brands and models and the actual response time of the ONUs/ONTs, is recorded in advance on an OLT, so that the OLT can determine the actual response time of the ONUs/ONTs according to the identifiers of the ONTs/ONTs. The OLT may calculate the length of the fiber between itself and an ONU/ONT, using the actual response time of the ONU/ONT, so as to obtain the precise length of the fiber between OLT and the ONU/ONT. Compared with the method for measuring fiber length using any response time value of the ONU/ONT within the error range defined by the protocol as the actual response time, Embodiment 2 improves the measurement precision of fiber length.

The response time is the same for the ONUs/ONTs having the same brand and model. Therefore, the actual response time of an ONU/ONT can be obtained when the actual response time of the ONUs/ONTs, which have the same brand and model is saved on an OLT. It is unnecessary to save the actual response time of all the ONUs/ONTs on the OLT. As compared with the Embodiment 1, Embodiment 2 features slightly lower complexity in manual setting and slightly higher expandability.

### Embodiment 3

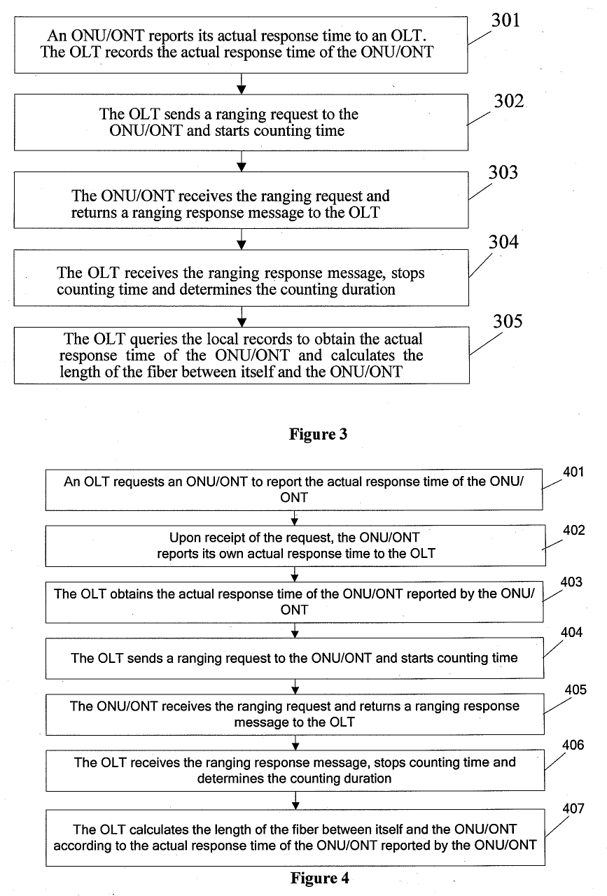

FIG. 3 shows the flowchart of a method for measuring fiber length according to Embodiment 3. The method may include the following acts.

In act 301, an ONU/ONT reports its actual response time to an OLT. The OLT records the actual response time of the ONU/ONT.

The ONU/ONT may initiatively report its actual response time to the OLT after being successfully registered or upon receiving a request from the OLT. After receiving the packet reported from the ONU/ONT, the OLT records the actual response time of the ONU/ONT.

The ONU/ONT may query the local records to obtain the ONU/ONT's actual response time and then report the response time to the OLT.

In the implementation of Embodiment 3, if the ONU/ONT does not locally record its own actual response time, the ONU/ONT may obtain its actual response time from its internal processing module and then report the actual response time to the OLT.

The method for the ONU/ONT reporting its actual response time to the OLT may include but is not limited to the following modes:

Mode 1: The actual response time of the ONU/ONT is carried in a Physical Layer Operation Administration and Maintenance (PLOAM) message sent to the OLT.

An unused field in a PLOAM message may be utilized to carry the actual response time of the ONU/ONT. Alternatively, the PLOAM message may be extended and the extended field may be used to carry the actual response time of the ONU/ONT. A new PLOAM message may be developed to carry the actual response time of the ONU/ONT. For example, a PLOAM message shown in Table 1 may be defined to carry the actual response time of the ONU/ONT.

TABLE 1
STRUCTURE of PLOAM message carrying
the actual response time of an ONU/ONT

| Byte No. | Content | Description |
|---|---|---|
| 1 | ONU/ONT identifier | Identifier of the ONU/ONT |
| 2 | PLOAM message type | Indicating that the message is |
| | flag | purposed to report the response |
| | | time of an ONU/ONT |
| 3 | Higher bits of the | Higher bits of the |
| | response time | response time |
| 4 | Lower bits of the | Lower bits of the |
| | response time | response time |
| 5-12 | Reserved | Reserved |

The actual response time of the ONU/ONT can be obtained by adding up the numeric value (in nanoseconds) composed of the higher bits of the response time (such as a binary value BBBBBBBB) and the lower bits of the response time (such as a binary value AAAAAAAABBBBBBBB) and the reference value. The available message structure is not limited to the message structure described here but other message structures may also be employed. The reference value may be 35 μs or other values.

The OLT may interpret the PLOAM message to obtain the actual response time of the ONU/ONT, and may locally record the actual response time of the ONU/ONT.

Mode 2: The actual response time of the ONU/ONT is carried in an Optical Network Unit Management and Control Interface (OMCI) message sent to the OLT.

A new attribute may be added to the existing managed entities in an OMCI message to carry the actual response time of the ONU/ONT. Alternatively, the existing OMCI message may be extended to add a new managed entity to carry the actual response time of the ONU/ONT.

The OLT may interpret the OMCI message to obtain the actual response time of the ONU/ONT, and may locally record the actual response time of the ONU/ONT.

Mode 3: The ONU/ONT may send its own actual response time as a data packet to the OLT through a data channel, that is, the actual response time of the ONU/ONT is carried in the data to be sent to the OLT, or the actual response time is sent directly as data to the OLT.

The OLT may read the data packet to obtain the actual response time of the ONU/ONT and may locally record the actual response time of the ONU/ONT.

The response time reported by the ONU/ONT to the OLT may be as precise as a matter of nanoseconds. The length of the fiber between the OLT and the ONU/ONT that is calculated based on the nanosecond-level precision of the response time is precise.

In act 302, the OLT sends a ranging request to the ONU/ONT and starts counting time.

To measure the length of the fiber from itself to the ONU/ONT, the OLT sends a ranging request to the ONU/ONT. The ranging request may be but is not limited to a ranging request message (D/S frame) defined in ITU-T G.984. The OLT starts locally counting time while sending the ranging request.

The pre-equalization delay designated to the receiving end by the OLT and the sending start time may be carried in the ranging request.

In act 303, the ONU/ONT receives the ranging request and returns a ranging response message to the OLT.

After receiving the ranging request message from the OLT, the ONU/ONT returns a ranging response message to the OLT after the actual response time of the ONU/ONT, the pre-equalization delay of the ONU/ONT, and the sending start time assigned by the OLT.

The pre-equalization delay may be the Pre-equalization assigned by the OLT and defined in ITU-T G.984, or other specification. The sending start time assigned by the OLT may be the Start defined in ITU-T G.984 or other specification. The ranging response message returned by the OLT may be but is not limited to the S/N response message defined in ITU-T G.984.

In act 304, the OLT receives the ranging response message, stops counting time and determines the counting duration.

The OLT receives the ranging response message from the ONU/ONT, stops counting time after receiving the ranging response message, and determines the counting duration. The counting duration is the difference between the time when time counting is started and the time when time counting is stopped.

In act 305, the OLT queries the local records to obtain the actual response time of the ONU/ONT and calculates the length of the fiber between itself and the ONU/ONT.

The OLT may query the local records generated in act 301 to obtain the actual response time of the ONU/ONT, and may determine the pre-equalization delay of the ONU/ONT and the waiting time of the ONU/ONT. The OLT can determine the total processing delay of the ONU/ONT, which is equal to the sum of the actual response time, the pre-equalization delay and the waiting time of the ONU/ONT.

The OLT may deduct the total processing delay of the ONU/ONT from the above-mentioned counting duration to obtain the round-trip time of a message transmitted between itself and the ONU/ONT, then divide the round-trip time by two (2) to obtain the single-trip time of a message transmitted between itself and the ONU/ONT, and multiply the single-trip time by the transmission speed of light in a fiber to obtain the length of the fiber between itself and the ONU/ONT.

According to Embodiment 3, the ONU/ONT may report its exact response time to the OLT after being registered. The OLT locally records the exact response time reported by the ONU/ONT. During the ranging calculation, the OLT queries the local records to obtain the exact response time of the ONU/ONT and then calculates the length of the fiber between OLT and the ONU/ONT according to the exact response time of the ONU/ONT.

In Embodiment 3, the ONU/ONT may report its exact response time in a message to the OLT after being registered. It is unnecessary to manually set the response time of the ONU/ONT on the OLT. Embodiment 3 lowers the probability of errors that may occur during the manual setting in Embodiment 1 or 2 and reduces the labor cost.

In the method for measuring fiber length according to Embodiment 3, when a new ONU/ONT is added at the subscriber side, it suffices that the new ONU/ONT reports its own response time to the OLT after being registered. Extra manual setting is not required. Embodiment 3 is easier to implement than Embodiments 1 and 2.

In Embodiment 3, after receiving a response time from an ONU/ONT, an OLT locally records this response time. When receiving multiple response time from multiple ONUs/ONTs, the OLT records the actual response times of these ONUs/ONTs. Therefore, in order to measure the length of the fiber from itself to and the ONU/ONT, the OLT may directly query the local records to obtain the actual response time of the ONU/ONT.

### Embodiment 4

FIG. 4 shows the flowchart of a method for measuring fiber length according to Embodiment 4. The method may include the following acts.

In act 401, an OLT requests an ONU/ONT to report the actual response time of the ONU/ONT.

Before measuring the length of the fiber between itself and the ONU/ONT, the OLT sends a message to the ONU/ONT, requests the ONU/ONT to report the actual response time of the ONU/ONT.

The modes for sending the request message are not limited to the modes mentioned in act 301 in Embodiment 3:

Mode 1: The request is carried in a PLOAM message to the ONU/ONT.

Mode 2: The request is carried in an OMCI message to the ONU/ONT.

Mode 3: The request is sent as a data packet via a data channel to the ONU/ONT.

For details about the modes, see the relevant descriptions in act 301 in Embodiment 3.

In act 402, upon receipt of the request, the ONU/ONT reports its own actual response time to the OLT.

After receiving the request, the ONU/ONT may query the local records to obtain its actual response time and then report the actual response time to the OLT.

If locally there is no actual response time of the ONU/ONT, the ONU/ONT may obtain the ONU/ONT actual response time from its internal processing module in real time and report the actual response time to the OLT.

The ONU/ONT may report its actual response time in one of the following (including but not limited to) three modes:

Mode 1: The actual response time is carried in a PLOAM message to the OLT.

Mode 2: The actual response time is carried in an OMCI message to the OLT.

Mode 3: The actual response time is sent as a data packet via a data channel to the OLT.

In act 403, the OLT obtains the actual response time of the ONU/ONT reported by the ONU/ONT.

The OLT receives the message reported by the ONU/ONT and interprets the message to obtain the actual response time of the ONU/ONT.

In act 404, the OLT sends a ranging request to the ONU/ONT and starts counting time.

The OLT may perform act 404 directly after act 401 or after act 403.

The OLT sends a ranging request to the ONU/ONT. The ranging request may be a ranging request message (D/S frame) defined in the ITU G.984. While sending the ranging request, the OLT starts locally counting time.

In act 405, the ONU/ONT receives the ranging request and returns a ranging response message to the OLT.

The act is similar to the act 304 in the Embodiment 3.

In act 406, the OLT receives the ranging response message, stops counting time and determines the counting duration.

The act is similar to the act 305 in Embodiment 3.

In act 407, the OLT calculates the length of the fiber between itself and the ONU/ONT according to the actual response time of the ONU/ONT reported by the ONU/ONT.

The calculation is similar to the calculation in act 305 in Embodiment 3, except for some differences in the technical solution. In Embodiment 3, the OLT needs to locally record the actual response times of each ONU/ONTs that are reported by the ONUs/ONTs after the ONUs/ONTs are registered. During each ranging, the OLT may query the local records to obtain the actual response times of the ONUs/ONTs so as to calculate the length of the fiber between itself and the ONUs/ONTs according to the actual response times of the ONUs/ONTs. In Embodiment 4, the OLT does not need to record and save the actual response times of each ONUs/ONTs. To measure the length of the fiber between the OLT and the ONU/ONT, the OLT requests the ONU/ONT to report the OLT's actual response time and then perform the calculation according to the actual response time reported by the ONU/ONT. Through the technical solution in Embodiment 4, the measured lengths of the fiber between the OLT and the ONUs/ONTs are precise.

Embodiment 4 lowers the probability of errors and reduces the labor cost. The method according to Embodiment 4 features higher expandability.

In Embodiment 4, an OLT sends a message to an ONU/ONT to request the ONU/ONT to report the actual response time of the ONU/ONT before measuring the length of the fiber between itself and the ONU/ONT. The OLT may request an ONU/ONT to report the actual response time of the ONU/ONT at any time before step 407 after the OLT itself and the ONU/ONT run normally.

### Embodiment 5

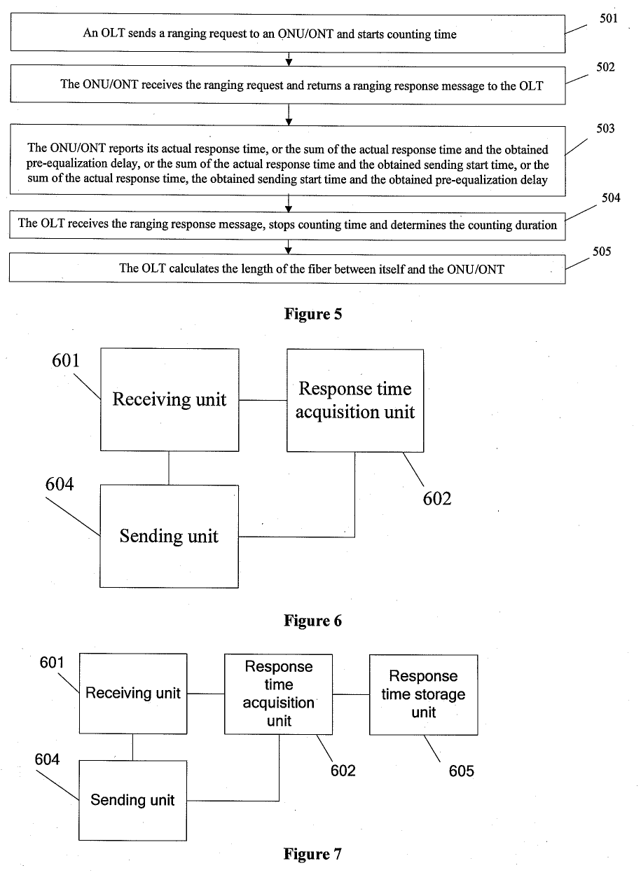

FIG. 5 shows the flowchart of a method for measuring fiber length according to Embodiment 5. The method may include the following acts.

In act 501, the OLT sends a ranging request to the ONU/ONT and starts counting time.

The act 501 is similar to the step 302 in Embodiment 3.

In act 502, the ONU/ONT receives the ranging request and returns a ranging response message to the OLT.

The act 502 is similar to the step 303 in Embodiment 3. Act 502 may be performed before or after the step 503.

After receiving the ranging request from the OLT, the ONU/ONT may interpret the ranging request to obtain the pre-equalization delay and the sending start time carried in the ranging request.

In act 503, the ONU/ONT reports its actual response time, or the sum of the actual response time and the obtained pre-equalization delay, or the sum of the actual response time and the obtained sending start time, or the sum of the actual response time, the obtained sending start time and the obtained pre-equalization delay.

In the Embodiment 5, the act 503 is similar to act 301 in Embodiment 3. The ONU/ONT may query the local records to obtain its actual response time, or obtain the actual response time from its internal processing module in real time when its actual response time is not locally recorded.

After obtaining its actual response time, the pre-equalization delay assigned by the OLT and the sending start time, the ONU/ONT may report its actual response time, or the sum of its actual response time and the obtained pre-equalization delay, or the actual response time and the obtained sending start time, or the sum of the actual response time, the obtained sending start time and the obtained pre-equalization delay to the OLT in a way similar to the description in act 301 in Embodiment 3.

The above information sent to the OLT may be carried in a PLOAM message, or an OMCI message, or a data packet sent via a data channel to the OLT.

In act 504, the OLT receives the ranging response message, stops counting time and determines the counting duration, just the same as act 304 in Embodiment 3.

In act 505, the OLT calculates the length of the fiber between itself and the ONU/ONT.

The OLT calculates the length of the fiber between itself and the ONU/ONT according to the duration obtained in the act 504 and any one of the followings: the reported actual response time of the ONU/ONT, the sum of the actual response time of the ONU/ONT and the pre-equalization delay, the sum of the actual response time of the ONU/ONT and the sending start time, and the sum of the actual response time of the ONU/ONT, the sending start time and the pre-equalization delay.

If the ONU/ONT reports the sum of its actual response time and the obtained pre-equalization delay in act 503, the OLT may calculate the sum of the actual response time of the ONU/ONT, the pre-equalization delay and the sending start time according to the reported information and the sending start time that is assigned to the ONU/ONT to obtain the total processing delay of the ONU/ONT. Then the OLT deducts the total processing delay of the ONU/ONT from the counting duration to obtain the round-trip time of a message transmitted between itself and the ONU/ONT, then divides the round-trip time by 2 to obtain the single-trip time of a message transmitted between OLT and the ONU/ONT, and multiplies the single-trip time by the transmission speed of light in a fiber to obtain the length of the fiber between itself and the ONU/ONT.

If the ONU/ONT reports the sum of its actual response time and the assigned sending start time in act 503, the OLT may calculate the sum of the actual response time of the ONU/ONT, the sending start time and the pre-equalization delay according to the reported information and the pre-equalization delay that is assigned to the ONU/ONT to obtain the total processing delay of the ONU/ONT. Then the OLT calculates the length of the fiber between OLT and the ONU/ONT according to the total processing delay of the ONU/ONT, the counting duration of the OLT itself, and the transmission speed of light in a fiber.

If the ONU/ONT reports the sum of its actual response time, the assigned pre-equalization delay and the assigned sending start time in act 503, the OLT may calculate the sum of the three given in the reported information to obtain the total processing delay of the ONU/ONT. Then the OLT calculates the length of the fiber between OLT and the ONU/ONT according to the total processing delay of the ONU/ONT, the counting duration of the OLT, and the transmission speed of light in a fiber.

In Embodiment 5, after sending a ranging request in act 501 but before the ranging calculation in act 505, the OLT may calculate the length of the fiber between OLT and the ONU/ONT according to the message from the ONU/ONT that carries the sum of the actual response time of the ONU/ONT and the pre-equalization delay, or the sum of the actual response time of the ONU/ONT and the sending start time, or the sum of the actual response time of the ONU/ONT, the sending start time and the pre-equalization delay. Compared with the method for measuring fiber length taking any response time value of the ONU/ONT within the error range defined by the protocol as the actual response time, Embodiment 5 improves the measurement precision of fiber length.

According to Embodiment 5, the ONU/ONT may report the sum of its actual response time and the obtained pre-equalization delay, or the sum of the actual response time and the obtained sending start time, or the sum of the actual response time, the obtained sending start time and the pre-equalization delay to the OLT after receiving a ranging request from the OLT. Manual setting of the information is not required on the OLT. Embodiment 5 lowers the probability of errors that may occur during the manual setting and thus reduces the labor cost.

Similar to Embodiment 3 and Embodiment 4, Embodiment 5 provides a method of higher expandability for measuring fiber length.

Those skilled in the art should understand that all or some of the acts in the methods for measuring fiber length according to the above-mentioned embodiments may be performed by a program instructing the relevant hardware. The program may be stored in an accessible storage media in a computer and may perform the following acts:

The OLT exchanges messages with the ONU/ONT to determine the message exchange duration;

The OLT determines the length of the fiber between itself and the ONU/ONT according to the message exchange duration, the actual response time of the ONU/ONT, the pre-equalization delay assigned by the OLT to the ONU/ONT, and the sending start time.

The above-mentioned storage media may be a ROM/RAM, magnetic disk, CD or other similar media.

The following detailed descriptions are about the ONU/ONT in the embodiments (Embodiments 6 and 7 are taken as an example).

### Embodiment 6

FIG. 6 shows a schematic structure of an ONU/ONT according to Embodiment 6, which may include a receiving unit 601, a response time acquisition unit 602, and a sending unit 604.

The receiving unit 601 is adapted to receive messages from an OLT. The OLT may send a ranging request message to the ONU/ONT, or a request message to the ONU/ONT to request the ONU/ONT to report the actual response time of the ONU/ONT.

The response time acquisition unit 602 is adapted to obtain the actual response time of the ONU/ONT. The response time acquisition unit 602 may obtain the actual response time of the ONU/ONT from, but not limited to, a local chip interface.

The sending unit 604 is adapted to send a response message to the OLT. The response message may be one of the following: a message that carries the actual response time of the ONU/ONT; a message that carries the sum of the actual response time and the pre-equalization delay assigned by the OLT; a message that carries the sum of the actual response time and the sending start time assigned by the OLT; a message that carries the sum of the actual response time, the pre-equalization delay assigned by the OLT, and the sending start time; or a ranging response message returned to the OLT to respond to the received ranging request message.

The sending unit 604 may report the actual response time, or the sum of the actual response time and the pre-equalization delay, or the sum of the actual response time and the sending start time, or the sum of the actual response time, the sending start time and the pre-equalization delay in a PLOAM message, or an OMCI message, or a data packet via a data channel to the OLT. The details are similar to the relevant descriptions in act 301 in Embodiment 3.

The sending unit 604 may send a message that carries the actual response time to the OLT according to the request from the OLT received by the receiving unit 601, or may initiate a message that carries the actual response time to the OLT after the ONU/ONT is successfully registered, depending on the pre-defined communication protocol.

As shown in FIG. 7, the ONU/ONT in Embodiment 6 may further include a response time storage unit 605 adapted to store the actual response time of the ONU/ONT.

The response time acquisition unit 602 may query the response time storage unit 605 to obtain the actual response time of the ONU/ONT.

As can be seen from above, the ONU/ONT in Embodiment 6 may read the actual response time of the ONU/ONT in real time and then send a message that carries the actual response time of the ONU/ONT to the OLT, so that the OLT can obtain the response time of the ONU/ONT to calculate the length of the fiber from the OLT itself to the ONU/ONT.

The ONU/ONT in Embodiment 6 can report its actual response time in a message to the OLT. Manual setting is not required on the OLT. Embodiment 6 avoids the errors that may occur during manual setting and reduces the labor cost.

When a new ONU/ONT is added at the subscriber side, it is only necessary to report the actual response time of the new ONU/ONT to the OLT. Extra manual setting is not required. The ONU/ONT in Embodiment 6 is more convenient to deploy.

### Embodiment 7

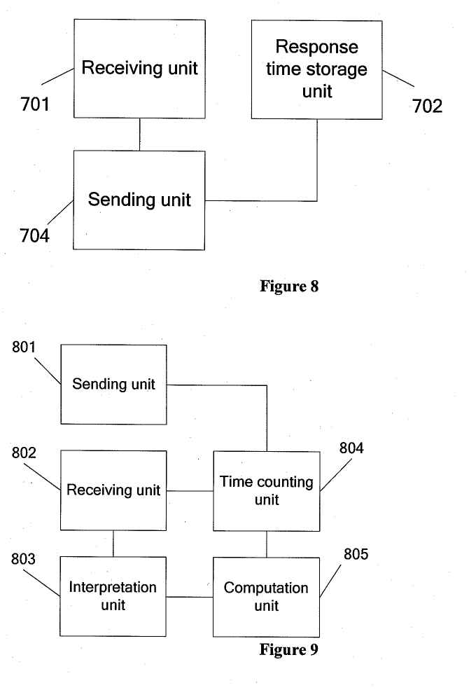

FIG. 8 shows a schematic structure of an ONU/ONT according to Embodiment 7, which may include a receiving unit 701, a response time storage unit 702 and a sending unit 704.

The receiving unit 701 is adapted to receive messages from the OLT. The OLT may send a ranging request message to the ONU/ONT, or a request message to the ONU/ONT to request the ONU/ONT to report the actual response time of the ONU/ONT.

The response time storage unit 702 is adapted to store the actual response time of the ONU/ONT. The ONU/ONT may record its actual response time in the response time storage unit 702.

The response time storage unit 702 may be but is not limited to a Flash or other similar storage unit.

The actual response time stored in the response time storage unit 702 may be pre-stored by the manufacture or may be stored after be read out from a chip interface of the ONU/ONT.

The sending unit 704 is adapted to send messages to the OLT. The messages sent by the sending unit 704 to an OLT may be one of the following: a message that carries the actual response time of the ONU/ONT; a message that carries the sum of the actual response time and the pre-equalization delay assigned by the OLT; a message that carries the sum of the actual response time and the sending start time assigned by the OLT; a message that carries the sum of the actual response time, the pre-equalization delay assigned by the OLT, and the sending start time; a ranging response message returned to the OLT to respond to the received ranging request message.

The above-mentioned actual response time is the actual response time of the ONU/ONT stored in the response time storage unit 702.

The sending unit 704 may report the information relating to the processing delay of the ONU/ONT to the OLT. The information includes the actual response time of the ONU/ONT, or the sum of the actual response time and the pre-equalization delay, or the sum of the actual response time and the sending start time, or the sum of the actual response time, the sending start time and the pre-equalization delay. The information relating to the processing delay of the ONU/ONT may be sent in a PLOAM message, or an OMCI message, or a data packet via a data channel to the OLT. The details are similar to the relevant descriptions in step 301 in Embodiment 3.

The sending unit 704 may send a message that carries the actual response time to the OLT according to a request from the OLT received by the receiving unit 701, or may initiate a message that carries the actual response time to the OLT after the ONU/ONT is successfully registered, depending on the pre-defined communication protocol.

Similar to the Embodiment 6, the ONU/ONT in Embodiment 7 may read the actual response time of the ONU/ONT in real time and then send a message that carries the actual response time to the OLT, so that the OLT can obtain the response time of the ONU/ONT to calculate the exact length of the fiber from the OLT itself to the ONU/ONT.

The ONU/ONT in Embodiment 7 can report its actual response time in a message to the OLT. Manual setting is not required on the OLT. Embodiment 7 avoids the errors that may occur during manual setting and reduces the labor cost.

When a new ONU/ONT is added at the subscriber side, it is only necessary to report the actual response time of the new ONU/ONT to the OLT. Extra manual setting is not required. The ONU/ONT in Embodiment 7 is more convenient to deploy.

The ONU/ONT in Embodiment 7 may be in a form of hardware or a software function module. The device in Embodiment 7 may be sold or used as an independent product, or may be stored in an accessible storage media in a computer.

The following detailed descriptions are about the OLT (Embodiments 8, 9 and 10 are taken as an example).

### Embodiment 8

FIG. 9 shows a schematic structure of an OLT according to Embodiment 9, which may include a sending unit 801, a receiving unit 802, an interpretation unit 803, a time counting unit 804 and a computation unit 805.

The sending unit 801 is adapted to send messages to the ONUs/ONTs. The sending unit 801 may send a ranging request message to the ONUs/ONTs, requesting the ONUs/ONTs to report the actual response time of themselves.

The receiving unit 802 is adapted to receive messages reported by ONUs/ONTs.

The receiving unit 802 may receive one of the following messages reported by the ONUs/ONTs: a ranging response message returned by the ONU/ONT; a message that carries the actual response time of the ONU/ONT; a message that carries the sum of the actual response time of the ONU/ONT and the pre-equalization delay assigned by the OLT to the ONU/ONT; a message that carries the sum of the actual response time of the ONU/ONT and the sending start time assigned by the OLT to the ONU/ONT; a message that carries the sum of the actual response time of the ONU/ONT, the pre-equalization delay assigned by the OLT to the ONU/ONT, and the sending start time.

The message mentioned above may be but is not limited to a PLOAM message, or an OMCI message, or a data packet sent via a data channel.

The interpretation unit 803 is adapted to: interpret a message carrying the actual response time of the ONU/ONT received by the receiving unit 802, so as to obtain the actual response time of the ONU/ONT; or interpret a message carrying the sum of the actual response time of the ONU/ONT and the pre-equalization delay assigned by the OLT to the ONU/ONT received by the receiving unit 802 so as to obtain the sum of the actual response time of the ONU/ONT and the pre-equalization delay; or interpret a message carrying the sum of the actual response time of the ONU/ONT and the sending start time assigned by the OLT to the ONU/ONT received by the receiving unit 702, so as to obtain the sum of the actual response time of the ONU/ONT and the sending start time; or interpret a message carrying the sum of the actual response time of an ONU/ONT, the pre-equalization delay assigned by the OLT to the ONU/ONT, and the sending start time received by the receiving unit 702, so as to obtain the sum of the actual response time of the ONU/ONT, the pre-equalization delay, and the sending start time.

The time counting unit 804 is adapted to count the time and determine the counting duration.

When the sending unit 801 sends a ranging request to the ONU/ONT, the time counting unit 804 starts counting time. When the receiving unit 802 receives a ranging response message from the ONU/ONT, the time counting unit 804 stops counting time. The counting duration equals the difference between the start time of time counting and the end time of time counting.

The computation unit 805 is adapted to calculate the length of the fiber between the OLT and the ONU/ONT as follows: deducting the total processing delay of the ONU/ONT from the counting duration determined by the time counting unit 804 to obtain a certain value, dividing the value by 2, and then multiplying the result by the transmission speed of light in a fiber (the transmission speed for example, is 2×10⁸) to obtain the length of the fiber between the OLT and the ONU/ONT.

The total processing delay of the ONU/ONT is the sum of the actual response time of the ONU/ONT, the pre-equalization delay of the ONU/ONT known to the OLT, and the sending start time of the ONU/ONT that is known to the OLT. The pre-equalization delay of the ONU/ONT and the sending start time of the ONU/ONT are the processing delay assigned by the OLT to the ONU/ONT. The total processing delay of the ONU/ONT can be determined.

If the interpretation unit 803 interprets the message previously mentioned and obtains the actual response time of the ONU/ONT, the computation unit 805 may add up the obtained actual response time of the ONU/ONT, the known pre-equalization delay assigned by the OLT to the ONU/ONT, and the sending start time to obtain the total processing delay of the ONU/ONT.

If the interpretation unit 803 interprets the message previously mentioned and obtains the sum of the actual response time of the ONU/ONT and the pre-equalization delay, the computation unit 805 may add up the sum of the actual response time of the ONU/ONT and the pre-equalization delay, and the sending start time that the OLT assigns to the ONU/ONT to obtain the total processing delay of the ONU/ONT;

If the interpretation unit 803 interprets the message previously mentioned and obtains the sum of the actual response time of the ONU/ONT and the sending start time, the computation unit 805 may add up the sum of the actual response time of the ONU/ONT and the sending start time, and the pre-equalization delay that the OLT assigns to the ONU/ONT to obtain the total processing delay of the ONU/ONT.

If the interpretation unit 803 interprets the message previously mentioned and obtains the sum of the actual response time of the ONU/ONT, the pre-equalization delay and the sending start time, the computation unit 805 may directly obtain the total processing delay of the ONU/ONT from the value obtained after the interpretation unit 803 interprets the message.

The computation unit 805 of the OLT in Embodiment 8 calculates the exact length of the fiber between the OLT and the ONU/ONT according to the actual total processing delay of the ONU/ONT. The actual total processing delay of the ONU/ONT is composed of the actual response time of the ONU/ONT, the pre-equalization delay assigned by the OLT to the ONU/ONT, and the sending start time. Compared with the OLT that calculates the length of the fiber between the OLT and the ONU/ONT using an approximate value of the actual response time within the error range defined by the protocol, the OLT in Embodiment 8 calculates the length of the fiber between the OLT and the ONU/ONT in an more precise way.

The interpretation unit 803 of the OLT in Embodiment 8 of the present invention can obtain the exact response time of an ONU/ONT, or the sum of the actual response time and the sending start time, or the actual response time and the pre-equalization, or the sum of the actual response time, the pre-equalization delay and the sending start time from the message received by the receiving unit 802. The OLT can calculate the length of the fiber between the OLT and the ONU/ONT based on the obtained information. Manual setting is not required on the OLT. Embodiment 8 avoids the errors that may occur during manual setting and reduces the labor cost.

### Embodiment 9

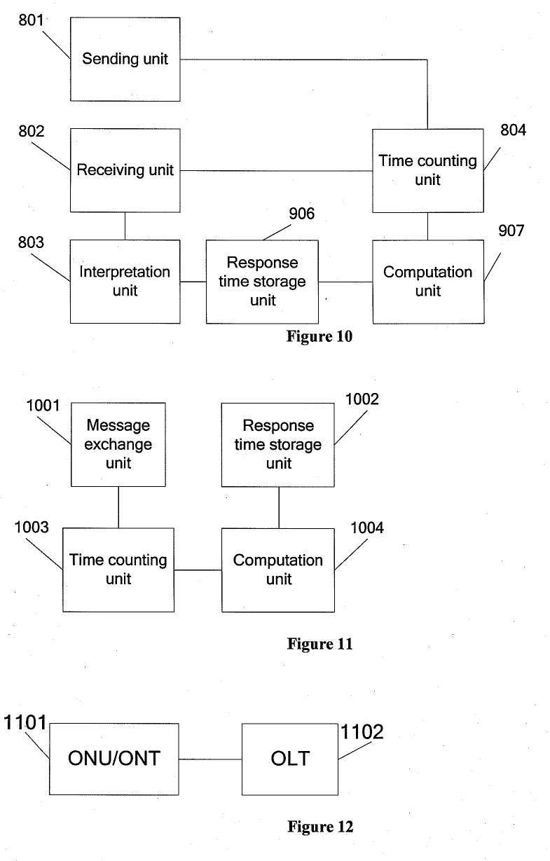

FIG. 10 shows a schematic structure of an OLT according to Embodiment 9. As shown in FIG. 10, the OLT differs from the OLT in Embodiment 8 in further including a response time storage unit 906 and a computation unit 907.

The response time storage unit 906 is adapted to store the information relating to the processing delay of the ONU/ONT that is obtained after the interpretation unit 803 interprets the message previously mentioned. The information relating to the processing delay includes the actual response time of the ONU/ONT.

The computation unit 907 is adapted to calculate the length of the fiber between the OTL and the ONU/ONT. During the calculation, the computation unit 907 adds up the actual response time of the ONU/ONT stored in the response time storage unit 806, the pre-equalization delay assigned by the OLT to the ONU/ONT, and the known sending start time assigned by the OLT to the ONU/ONT to obtain the total processing delay of the ONU/ONT, deducts the total processing delay of the ONU/ONT from the counting duration determined by the time counting unit 804 to obtain a value, then divides the value by 2, and finally multiplies the result by the transmission speed of light in a fiber (the transmission speed is, for example, 2×10⁸) to obtain the length of the fiber between the OLT and the ONU/ONT.

Similar to Embodiment 8, Embodiment 9 provides the OLT that calculates the length of the fiber between the OLT itself and the ONU/ONT in a precise way.

As compared with the OLT in Embodiment 8, the OLT in Embodiment 9 has an additional response time storage unit 906, which enables the OLT to locally store the actual response time of various ONUs/ONTs and enables the OLT to obtain the actual response time of an ONU/ONU from the data locally stored to calculate the length of the fiber between the OLT itself and the ONU/ONT.

### Embodiment 10

FIG. 11 shows a schematic structure of an OLT according to Embodiment 10, which may include a message exchange unit 1001, a time counting unit 1002, a response time storage unit 1003 and a computation unit 1004.

The message exchange unit 1001 is adapted to exchange messages with ONUs/ONTs. The process of message exchange with the ON U/ONT includes sending a ranging request to the ONU/ONT and receiving a ranging response message from the ONU/ONT.

The time counting unit 1002 is adapted to determine the duration of message exchange between the message exchange unit 1001 and the ONU/ONT. When the message exchange unit 1001 sends a ranging request to the ONU/ONT, the time counting unit 902 starts counting time. When the message exchange unit 1001 receives a ranging response message from the ONU/ONT, the time counting unit 804 stops counting time. The counting duration equals the difference between the start time of time counting and the end time of time counting;

The response time storage unit 1003 is adapted to store the actual response time of various ONUs/ONTs. The actual response time of each ONU/ONT stored in the response time storage unit 1003 may be manually set but is not limited to manual setting.

The actual response time of each ONU/ONT stored in the response time storage unit 1003 corresponds to the identifier of each ONU/ONT, or corresponds to the brand and model of each ONU/ONT. The response time storage unit 1003 may be, but is not limited to, a Flash or other similar storage unit.

The computation unit 1004 is adapted to determine the length of the fiber between the ONU/ONT and the OLT according to the duration determined by the time counting unit 1002, the actual response time of the ONU/ONT stored in the response time storage unit 1003, the pre-equalization delay assigned by the OLT to the ONU/ONT, and the sending start time assigned by the OLT to the ONU/ONT. The computation unit 1004 is similar to the computation unit 805 in Embodiment 8 and the computation unit 907 in Embodiment 9.

The total processing delay of the ONU/ONT is the sum of the actual response time of the ONU/ONT stored in the response time storage unit 1003, the pre-equalization delay of the ONU/ONT that is known to the OLT, and the sending start time of the ONU/ONT that is known to the OLT. The pre-equalization delay of the ONU/ONT and the sending start time of the ONU/ONT are the processing delay assigned by the OLT to the ONU/ONT.

In Embodiment 10, the OLT can query the records stored in the response time storage unit 1004 to obtain the actual response times of the ONUs/ONTs so as to calculate the length of the fiber between the OLT and the ONUs/ONTs.

The response time storage unit 1003 stores the exact actual response time of each ONU/ONT. During the calculation, the OLT queries the records stored in the response time storage unit 1003 to obtain the actual response times of the ONUs/ONTs and then calculates the exact lengths of the fiber between the OLT and the ONUs/ONTs based on the actual response time of the ONU/ONT. Compared with the OLT that calculates the length of the fiber between the OLT and the ONU/ONT using an approximate value of the actual response time within the error range defined by the protocol, the OLT in Embodiment 10 calculates the length of the fiber between the OLT and the ONU/ONT in an more precise way.

The OLT in Embodiment 10 may be in a form of hardware or a software function module. The device in Embodiment 10 may be sold or used as an independent product, or may be stored in an accessible storage media in a computer.

The following detailed descriptions are about an optical network system according to the present embodiments (Embodiment 11 is taken as an example).

### Embodiment 11

FIG. 12 shows a schematic structure of a communication system (the above-mentioned optical network system) according to Embodiment 11, which may include an ONU/ONT 1101 and an OLT 1102.

The ONU/ONT 1101 is adapted to exchange messages with the OLT 1102.

The ONU/ONT 1101 may adapt a structure shown in FIG. 6 or a structure shown in FIG. 8.

The OLT 1102 is adapted to exchange messages with the ONU/ONT 1101, determine the duration of message exchange with the ONU/ONT 1101, and determine the length of the fiber between itself and the ONU/ONT 1001 according to the determined actual response time of the ONU/ONT 1101, the pre-equalization delay assigned to the ONU/ONT 1001 and the sending start time.

The OLT 1102 may use a structure shown in FIG. 9, or a structure shown in FIG. 10, or a structure shown in FIG. 11.

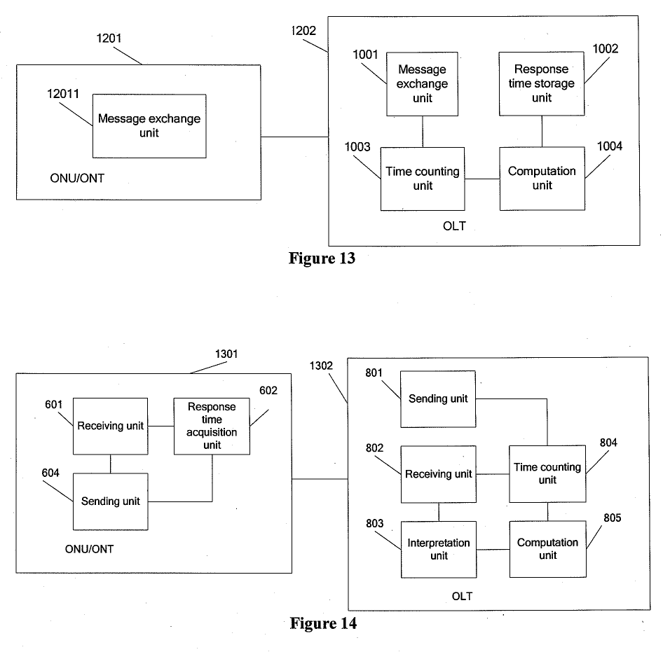

FIG. 13 shows a schematic structure of a communication system according to one embodiment of the present invention. The communication system includes an ONU/ONT 1201 and an OLT 1202.

As shown in FIG. 13, the ONU/ONT 1201 may include a message exchange unit 12011 adapted to exchange messages with the OLT 1202. The message exchange unit 12011 receives a ranging request from the message exchange unit 1001 of the OLT 1202 and returns a ranging response message to the message exchange unit 1101 of the OLT 1202.

The OLT 1202 may use a structure shown in FIG. 11. The OLT 1202 may include a message exchange unit 1001, a time counting unit 1003, a response time storage unit 1002, and a computation unit 1004. For details on the principles of the units, see the relevant descriptions in Embodiment 10.

As can be seen from above, in a communication system shown in FIG. 13, the response time storage unit 1003 of the OLT 1202 pre-stores the actual response times of ONUs/ONTs 1201 in various brands and models, or the actual response time of each ONU/ONT 1201. The OLT 1202 queries the records stored in the response time storage unit 1002 to obtain the actual response time of the ONU/ONT 1201, and then calculates the length of the fiber between the OTL 1202 itself and the ONU/ONT 1201 based on the actual response time of the ONU/ONT 1201. In the communication system shown in FIG. 13, the precision of the measured length of the fiber between the OLT 1202 and the ONU/ONT 1201 is greatly improved as compared with that according to the prior art.

FIG. 14 shows a schematic structure of a communication system including the ONU/ONT shown in FIG. 6 and the OLT shown in FIG. 9.

As shown in FIG. 14, the ONU/ONT 1301 may include a receiving unit 601, a response time acquisition unit 602, and a sending unit 604. The receiving unit 601 is adapted to receive messages sent by a sending unit 801 of the OLT 1302 (see the relevant descriptions concerning Embodiment 6 for details). The response time acquisition unit 602 (see the relevant descriptions concerning Embodiment 6 for details on the principles of the response time acquisition unit 602) is used for acquisition. The sending unit 604 is adapted to send messages to a receiving unit 802 of the OLT 1302 (see the relevant descriptions concerning Embodiment 6 for details).

The OLT 1302 may include a sending unit 801, a receiving unit 802, an interpretation unit 803, a time counting unit 804 and a computation unit 805. For details on the principles of these units, see the relevant descriptions concerning Embodiment 6.

In the communication system shown in FIG. 14, the sending unit 604 of the ONU/ONT 1301 can report the actual response time of the ONU/ONT 1301, or the sum of the actual response time and the pre-equalization delay assigned by the OLT 1302 to the ONU/ONT 1301, or the sum of the actual response time, and the sending start time assigned by the OLT 1302 to the ONU/ONT 1301, or the sum of the actual response time, the pre-equalization delay assigned by the OLT 1302 to the ONU/ONT 1301 and the sending start time to the OLT 1302, so that the interpretation unit 803 of the OLT 1302 can interpret the reported information to obtain the relevant information and then the computation unit 805 can measure the length of the fiber between the OLT 1302 and the ONU/ONT 1301 according to the information obtained after the interpretation. In a communication system shown in FIG. 13, the precision of the measured length of the fiber between the OLT 1202 and the ONU/ONT 1201 is greatly improved as compared with that according to the prior art.

In the communication system shown in FIG. 14, manual setting is not required. The communication system shown in FIG. 14 has higher expandability than the communication system shown in FIG. 13.

A communication system may comprise an ONU/ONT shown in FIG. 6 and an OLT shown in FIG. 10 or FIG. 11, or may comprise an ONU/ONT shown in FIG. 8 and an OLT shown in FIG. 9, or FIG. 10, or FIG. 11. For details on the ONUs/ONTs and the OLTs.

In sum, the OLT may obtain a highly-precise length of the fiber between the OLT and the ONU/ONT through calculation using the actual response time of the ONU/ONT. In the communication system according to the present embodiments, the precision of the measured length of the fiber between the OLT and the ONU/ONT is improved.

In one embodiment, computer readable media comprises computer program codes for measuring the fiber length between the OLT and the ONT/ONU using the methods according to the embodiments of the present invention. The computer program codes may be logic encoded in one or more tangible media for execution. As used herein, logic encoded in one or more tangible media is defined as instructions that are executable by a programmed processor and that are provided on computer-readable storage media, memories, or a combination thereof.

While this invention has been particularly shown and described with reference to preferred embodiments thereof, it will be understood by those skilled in the art that various changes in form and details may be made therein without departing from the spirit and scope of the invention as defined by the appended claims.

We claim:

1. A method for measuring a fiber length between a first optical network device and a second optical network device, comprising:
sending a first message from the first optical network device to the second optical network device;
receiving a response message from the second optical network device;
determining a time duration between sending the first message and receiving the response message;
obtaining an actual response time of the second optical network device and a waiting time assigned to the second optical network device; and
determining the fiber length based on the time duration, the waiting time, and the actual response time.

2. The method according to claim 1, wherein obtaining the actual response time of the second optical network device includes querying a mapping table stored in the first optical network device.

3. The method according to claim 2, wherein a mapping of the mapping table is between the actual response time of the second optical network device and an identifier of the second optical network device.

4. The method according to claim 2, wherein a mapping of the mapping table is between the actual response time and a brand and model of the second optical network.

5. The method according to claim 1, wherein obtaining the actual response time comprises:
receiving a second message carrying the actual response time from the second optical network device; and
obtaining the actual response time using the second message.

6. The method according to claim 5, further comprising storing the second message in the first optical network device after receiving the second message.

7. The method according to claim 5, further comprising sending a third message to the second optical network device for requesting the actual response time before receiving the second message carrying the actual response time.

8. The method according to claim 5, wherein the second message is at least one of a physical layer operation administration and maintenance message, an optical network unit management and control interface message, or data.

9. The method according to claim 5, wherein the first message includes a pre-equalization delay and a sending start time assigned to the second optical network device by the first optical network device, the waiting time is a sum of the pre-equalization delay and the sending start time.

10. An optical line terminal, comprising:
a sending unit that is adapted to send a first message to an optical network device;
a receive unit that is adapted to receive a response message from the optical network device;
a time counting unit that is adapted to determine a duration between sending the first message and receiving the response message;
a response time acquisition unit that is adapted to obtain a actual response time of the optical network device; and
a computation unit that is adapted to calculate a fiber length between the optical line terminal and the optical network device according to the duration and the actual response time of the optical network device.

11. The optical line terminal according to claim 10, further comprising a response time storage unit that is adapted to store information relating to the actual response time, wherein the response time acquisition unit is adapted to obtain the actual response time of the optical network device from the response time storage unit.

12. The optical line terminal according to claim 11, wherein the information relating to the actual response time is a mapping table stored in the optical line terminal, the response time acquisition unit being adapted to obtain the actual response time by querying the mapping table.

13. The optical line terminal according to claim 12, wherein a mapping of the mapping table is between the actual response time and an identifier of the optical network device or a brand and model of the optical network device.

14. The optical line terminal according to claim 10, wherein the response message carries the actual response time, the response time acquisition unit being an interpreting unit that is adapted to interpret the response message to obtain the actual response time.

15. The optical line terminal according to claim 10, wherein the receiving unit is adapted to receive a second message carrying the actual response time, the response time acquisition unit being an interpreting unit that is adapted to interpret the second message to obtain the actual response time.

16. The optical line terminal according to claim 15 further comprising a response time storage unit that is adapted to store the second message.

17. An optical network device, comprising:
a receiving unit that is adapted to receive a first message sent from an optical line terminal;
a response time acquisition unit that is adapted to obtain an actual response time of the optical network device; and
a sending unit that is adapted to send a second message carrying the actual response time to the optical line terminal.

18. The optical network device according to claim 17, further comprising a response time storage unit adapted to store the actual response time, wherein the response time acquisition unit is adapted to obtain the actual response time from the response time storage unit.

19. The optical network device according to claim 17, wherein the first message is a ranging request message, and the second message is a response message responding to the ranging request message.

20. The optical network device according to claim 17, wherein the first message is a ranging request message, and the second message is a message sent voluntarily.

21. A computer readable media, comprising logic encoded in the computer readable media, the logic when executed operable to:
send a first message to the second optical network device;
receive a response message from the second optical network device;
determine a duration between sending the first message and receiving the response message;
obtain a actual response time of the second optical network device and a waiting time assigned to the second optical network device; and
determine the fiber length according to the duration, the waiting time, the actual response time.
